(19) United States
(12) Patent Application Publication
(10) Pub. No.: US 2009/0109962 A1
(43) Pub. Date: Apr. 30, 2009

(54) Method and apparatus for dynamically allocating and routing telephony endpoints

(76) Inventors: Joseph Hosteny, Pittsburgh, PA (US); David Graham, Cranberry Township, PA (US)

Correspondence Address: Niro, Scavone, Haller & Niro, Suite 4600, 181 W. Madison, Chicago, IL, 60602, US

(21) Appl. No.: 11/978,237

(22) Filed: Oct. 27, 2007

(51) Int. Cl. H04L 12/66

(52) U.S. Cl. 370/352

(57) ABSTRACT

A client application sends a message to an endpoint server. The message contains parameters including allocation constraints. The endpoint server allocates an endpoint, such as a PSTN number, according to those constraints. The endpoint server maintains the state of the endpoint in a database. Various authentication and credentialing information is included in the database. The endpoint server configures a route through a proxy PBX for the endpoint, and returns the endpoint to the client. When desired, the client releases the endpoint by sending another message to the endpoint server to de-allocate the endpoint. The endpoint server removes the route to the endpoint, and marks the endpoint as available in the database.

### BACKGROUND OF THE INVENTION

The invention pertains to the dynamic allocation of telephony endpoints, such as traditional PSTN numbers, via a programmatic interface, and the configuration of routing information through a PBX necessary for a client to utilize those endpoints. The process allocates endpoints from a pool of available endpoints. Various constraints can be set on the allocation strategy. Records in a database maintain information about the endpoints, such as allocation state and credential information necessary to use the endpoints if they are routed through another party, such as a LEC (Local Exchange Carrier) for PSTN numbers. The process additionally generates authentication information specific to a current allocation of an endpoint through a proxy PBX, so that the process may revoke client access to the endpoint and associated route when the endpoint is de-allocated. Optionally, the process can communicate proxy PBX control or data messages to a client PBX.

### SUMMARY OF THE INVENTION

There is an apparatus and method, with various embodiments, for dynamically allocating telephony endpoints programmatically via communication with an endpoint server and routing those endpoints via a PBX. This server allocates endpoints from a pool according to constraints specified by a client connecting to the server. These endpoints can be VoIP endpoints, such as SIP (Session Initiation Protocol) addresses, or telephone numbers on the PSTN (Public Switched Telephone Network). The endpoint server maintains records for the pool of endpoints, and updates these records on a database server to maintain information about their allocation state. The endpoint server returns routing information for an endpoint that represents a route through a PBX that can be configured by the endpoint server.

The endpoint server can accomplish other functions, such as the authentication of request from clients, and configuration of a PBX. The PBX can accomplish other functions, such as proxying communications with a gateway PBX provided by an IXC (Inter Exchange Carrier) or LEC (Local Exchange Carrier), or providing an interface through which an authenticated client may communicate control and data messages with it.

### DESCRIPTION OF THE DRAWINGS

FIG. 1 is a sequence diagram depicting the operation of an embodiment of the service.

### DETAILED DESCRIPTION OF THE INVENTION

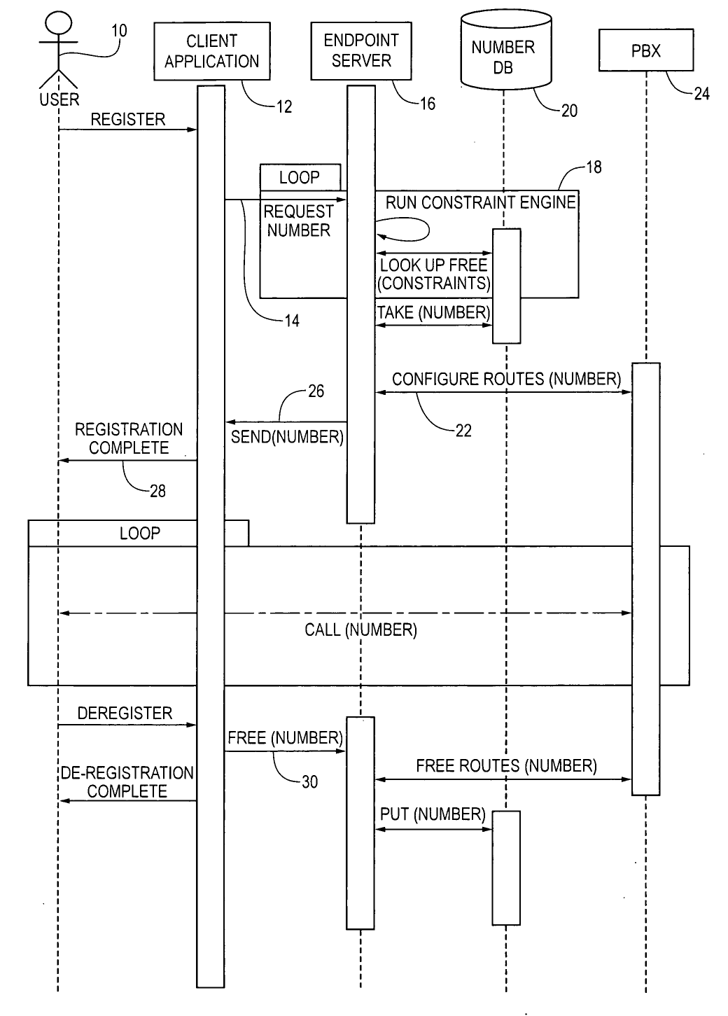

The service allows dynamic allocation of telephony endpoints via a programmatic interface available to clients of the endpoint server on a network, and the routing of traffic to and from those endpoints. Refer to FIG. 1, the sequence diagram, which depicts a typical flow of this embodiment of the service. In this FIGURE, the vertical direction or Y-axis represents time, with commencement at the top. Arrows represent messages sent by a user or by processes, for example, code executing on a machine. An arrow with a single barb represents asynchronous messages. An arrow with two barbs represents a synchronous message.

For example, a user 10 registers with a website having a client application 12. The website provides a VoIP service of some type which requires a specific telephone number on the PSTN for that user. The client application 12 then initiates a call 14 across a network to an endpoint server 16. The call includes constraints on the allocation strategy, such as a required area code for a PSTN number, or the capability to support multiple simultaneous inbound calls on that number.

The endpoint server 16, upon receiving the request, authenticates the caller via credentials provided in the call. Only an authorized client may be allowed to issue calls 14 to the endpoint server. Once the caller has been authenticated, the call parameters are processed for constraints, and the constraint engine on the endpoint server is invoked, as depicted in block 18. The constraint engine will attempt to best satisfy the requirements for the allocation of the endpoints. Some of the constraints may be requirements, such that if they are not met, the endpoint server will return a failure message to the client. Other constraints may be “soft,” in that if they are not met, the engine chooses a “best fit” and returns that to the client. For example, the website may request an area code in of 312 (in Chicago), but it may be acceptable to provide the area code 773 as well.

The endpoint server performs lookups in a database 20 that contains records of available endpoints. These lookups may be qualified by constraints derived, by the constraint engine, from the call to the endpoint server 16. The database 20 then returns a set of records. The constraint engine in block 18 processes this set. If the set contains an endpoint sufficient to satisfy the request, the constraint engine updates the record in the database 20 to indicate that the endpoint is now allocated. If the endpoint does not satisfy the constraints, then the constraint engine loop in block 27 continues. Subsequent iterations of the loop may relax the constraints invoked on the database lookups, provided that they do not violate any of the requirements indicated by the client 12. If no endpoint has been found, and the lookup constraints cannot be relaxed any further and still provide a satisfactory endpoint, then an error is returned to the client.

Once an endpoint has been allocated, but before notifying the client 12 of the result, the endpoint server configures the route to that endpoint. The endpoint server 16 sends a message 22 to a PBX (private branch exchange) 24 that is configurable by the endpoint server 16. The message 22 contains a configuration instruction for the PBX 24. This configuration message may include authentication information to register the PBX 24 with an IXC or LEC that may have jurisdiction over the endpoint. If the PBX 24 will act as a proxy to another PBX under the control of the client (the client PBX, which is not shown in the diagram), or if the PBX will communicate control and data messages directly with the client 12, then the configuration message 22 may also contain additional credential information generated by the endpoint server 16. This credential information is used for the purpose of authenticating, for example, client PBX registration requests with the proxy PBX. Since the endpoint server 16 grants these authentication credentials, it may also revoke them. Thus, it can ensure that, if the endpoint is returned by the client, the client will not be able to use a route to the endpoint anymore. This is desirable so that the endpoint may be reused securely by another client.

After the endpoint server 16 has sent the configuration message 22, it returns the endpoint to the client 12 via message 26. The user is advised by message 28. In an alternate embodiment, where the client has a PBX that communicates with the proxy PBX configured by the endpoint server 16, the authentication credentials generated by the endpoint server are also returned in the message 26 to the client.

Once the endpoint has been allocated, the route configured and the client notified of the endpoint, normal PBX operation may commence. Depending on the application, the PBX may perform different functions, such as bridging a call from the PSTN to the allocated endpoint. The optional client PBX may perform different functions depending on the application as well.

At some point in the future, the user 10 decides to deregister from the website. The website sends a message 30 to free the endpoint associated with the user 10 to the endpoint server 16. Upon receiving this message, the endpoint server 16 first removes the configured route on the PBX 24. Once the route has been removed, the endpoint record in the database 20 is updated to indicate that the endpoint is once again available.

Likewise, it will be appreciated by those skilled in the art that various changes, additions, omissions, and modifications can be made to the illustrated embodiments without departing from the spirit of the present invention. All such modifications and changes are intended to be covered by the claims.

We claim:

1. A method for making telephony endpoints available for procurement programmatically over a network, including the steps of:
Initiating a call from a client to a server to request an endpoint;
Performing a lookup in a database for an endpoint that meets the constraints specified in the call;
Associating an endpoint in the database with an authenticated client;
Configuring a PBX with routing information for that endpoint;
Returning the allocated endpoint to the client, along with any credential information needed to use the endpoint;

2. The method of claim 1 wherein the server is publicly addressable

3. The method of claim 1 wherein the request protocol is one of a group of protocols, including at least TCP and HTTP.

4. The method of claim 1 wherein the server authenticates the requests from the client

5. The method of claim 1 wherein the database is located on a network available to the server

6. The method of claim 1 wherein the server performs a lookup in the database for endpoints based upon constraints specified in the call from the client

7. The method of claim 1 wherein the server generates credentials valid for the current assignment of the endpoint

8. The method of claim 1 wherein the server configures the PBX to allow clients to connect with the current credentials for the endpoint generated by the server

9. An apparatus comprising:
A publicly addressable server;
A database server connected to the publicly addressable server;
A PBX connected to the publicly addressable server;
